(19) United States
(12) Patent Application Publication
(10) Pub. No.: US 2025/0377549 A1
(43) Pub. Date: Dec. 11, 2025

(54) OPTICAL SYSTEM, IMAGE DISPLAY APPARATUS INCLUDING OPTICAL SYSTEM, AND IMAGING APPARATUS

(71) Applicant: CANON KABUSHIKI KAISHA, Tokyo (JP)

(72) Inventor: TORU YATABE, Tochigi (JP)

(21) Appl. No.: 19/222,419

(22) Filed: May 29, 2025

(30) Foreign Application Priority Data
Jun. 7, 2024 (JP) 2024-092831

(51) Int. Cl. G02B 27/09; G02B 27/01; G02B 27/14; G02B 27/28

(52) U.S. Cl. CPC G02B 27/0955; G02B 27/0172; G02B 27/142; G02B 27/283; G02B 27/286

(57) ABSTRACT

Disclosed is an optical system for guiding light from a display side to an observation side is disclosed that includes an intermediate layer including a polarization separation element, a first lens, and a second lens. The first lens and the intermediate layer are cemented to each other through a sticky layer. The second lens and the intermediate layer are cemented to each other through an adhesive layer. A number of times the light passes through the sticky layer is greater than a number of times the light passes through the adhesive layer.

### BACKGROUND

### Field

The present disclosure relates to an optical system suitable for an image display apparatus such as a head-mounted display that enlarges and displays an original image displayed on a display element.

### Description of the Related Art

In recent years, in an image display apparatus such as a head-mounted display (HMD), an optical system in which an optical path is folded by using polarization reflection in order to shorten a total length of the apparatus is adopted. In such an optical system, a cemented optical element in which an optical element such as a lens, and an optical functional element such as a polarization separation element are cemented is used. In manufacture of the cemented optical element, an adhesive and a sticky agent are used to cement the optical element and the optical functional element. In an HMD discussed in Japanese Unexamined Patent Application Publication No. 2019-526075, a configuration in which optical elements such as a linear polarizer and a lens element are cemented to each other through an adhesive is discussed.

### SUMMARY

In manufacture of the cemented optical element, the sticky agent and the adhesive are used at appropriate cementing positions, which makes it possible to suppress reduction in image quality and to realize high optical performance.

An aspect of the present disclosure provides an optical system for guiding light from a display side to an observation side, with the optical system including an intermediate layer including a polarization separation element, a first lens, and a second lens. The first lens and the intermediate layer are cemented to each other through a sticky layer. The second lens and the intermediate layer are cemented to each other through an adhesive layer. A number of times the light passes through the sticky layer is greater than a number of times the light passes through the adhesive layer.

Further features of the present disclosure will become apparent from the following description of exemplary embodiments with reference to the attached drawings.

### BRIEF DESCRIPTION OF THE DRAWINGS

FIG. 1 is a cross-sectional view illustrating an optical system according to an exemplary embodiment.

FIG. 2 is a schematic diagram illustrating an image display apparatus according to the exemplary embodiment.

FIG. 3 is a diagram illustrating an optical path in the image display apparatus according to the exemplary embodiment.

FIGS. 4A to 4J are schematic diagrams illustrating a method of manufacturing the optical system according to the exemplary embodiment.

FIG. 5 is a cross-sectional view according to a first example.

FIG. 6 is a cross-sectional view according to a second example.

FIG. 7 is a cross-sectional view according to a third example.

FIG. 8 is a cross-sectional view according to a fourth example.

### DESCRIPTION OF THE EMBODIMENTS

An exemplary embodiment discussed in the present specification is described in detail with reference to drawings. The drawings may be drawn on scales different from actual scales for convenience. In the drawings, the same members are denoted by the same reference numerals, and repetitive description is omitted.

### (Optical System)

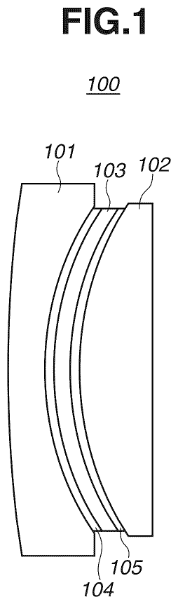

FIG. 1 is a cross-sectional view illustrating an optical system 100 according to the exemplary embodiment.

The optical system 100 includes a first lens 101, a second lens 102, an intermediate layer 103, a sticky layer 104, and an adhesive layer 105.

The first lens 101 and the second lens 102 are lenses made of a resin material such as cyclic olefin copolymer (COC), cycloolefin polymer (COP), acrylic, polycarbonate, and polyester. A surface of each of the first lens 101 and the second lens 102 may be provided with, for example, an antireflective (AR) coat film. In this case, the first lens 101 may consist of the first lens 101 and the film on the surface, and the second lens 102 may consist of the second lens 102 and the film on the surface.

The intermediate layer 103 includes a plurality of optical elements at least including a polarization separation element. Examples of the plurality of optical elements include a polarization separation element, an optical element including a semi-transmissive reflective surface such as a half mirror, and a ¼-wavelength plate. Examples of the polarization separation element include a multilayer reflective polarizer film, a polarization beam splitter, a wire grid film, and a circularly-polarized light selective reflective film.

The sticky layer 104 is made of an optically-transparent sticky resin material such as acrylic, silicone, rubber, and urethane. The first lens 101 and the intermediate layer 103 are cemented to each other through the sticky layer 104. Stickiness used herein indicates a material property that exhibits adhesiveness by receiving slight pressure for a short time at an ambient temperature. The sticky layer 104 can cement the optical elements with slight pressure for a short time as described above. For this reason, the sticky layer 104 is suitable for cementing a film element to a curved surface of a lens and the like.

The adhesive layer 105 is made of an optically-transparent adhesive of a resin material such as acrylic, epoxy, and urethane. The second lens 102 and the intermediate layer 103 are cemented to each other through the adhesive layer 105. The adhesive contains a photocurable resin or thermosetting resin, and a polymerization initiator. The adhesive is cured by energy of light such as ultraviolet light (UV) or heat, to form the adhesive layer 105. The adhesive layer 105 can bond the optical elements after relative positions of the optical elements are adjusted because the adhesive layer 105 is in a liquid form before energy necessary for curing is applied. For this reason, the adhesive layer 105 is suitable for cementing the optical elements.

Conditional inequalities that are preferably satisfied by optical systems according to examples are described herein.

A maximum half aperture angle of a surface (first cemented surface) of the first lens 101 cemented to the intermediate layer 103 is denoted by θ₁ [degree], and a maximum half aperture angle of a surface (second cemented surface) of the second lens 102 cemented to the intermediate layer 103 is denoted by θ₂ [degree]. At this time, the optical system 100 according to each of the examples preferably satisfies the following conditional inequalities expressed in Equations (1) and (2):

$$0 \leq {θ}_{1} \leq 30 , \qquad ( 1 )$$

$$0 \leq {θ}_{2} \leq 30. \qquad ( 2 )$$

The conditional inequalities of Equations (1) and (2) relate to the maximum half aperture angles of the surfaces of the first lens 101 and the second lens 102 cemented to the intermediate layer 103. The maximum half aperture angle indicates a maximum value of an angle formed by a surface normal at an optional point on a lens surface and an optical axis of the lens. When the conditional inequalities of Equations (1) and (2) are satisfied, each of the first lens 101 and the second lens 102 can be appropriately cemented to the intermediate layer 103.

When the maximum half aperture angle exceeds an upper limit of each of the conditional inequalities of Equations (1) and (2), floating and peeling occur at an end part of each of the first lens 101 and the second lens 102. An extension amount of the intermediate layer 103 is increased, which may deteriorate optical performance. In a case where each of the first lens 101, the second lens 102, and the intermediate layer 103 has a planar structure, the maximum half aperture angles θ₁ and θ₂ are zero degrees. Accordingly, the maximum half aperture angles θ₁ and θ₂ do not fall below lower limits of the conditional inequalities of Equations (1) and (2), respectively.

A thickness of the intermediate layer 103 in a surface normal direction on the optical axis when the intermediate layer 103 is cemented to the first lens 101 is denoted by t₁, and a thickness of the intermediate layer 103 in the surface normal direction at an optional position is denoted by t₂. At this time, the optical system 100 according to each of the examples preferably satisfies the following conditional inequality expressed in Equation (3),

$$0.95 \leq {t}_{2} / {t}_{1} \leq 1.05 . \qquad ( 3 )$$

The conditional inequality of Equation (3) relates to thickness variation of the intermediate layer 103. When the conditional inequality of Equation (3) is satisfied, variation at a center part and an outer peripheral part of the intermediate layer 103 is reduced. Accordingly, the intermediate layer 103 can be cemented to the first lens 101 while suppressing degradation in optical performance. When the value exceeds an upper limit of the conditional inequality of Equation (3), the thickness at the center part of the intermediate layer 103 is reduced, and the optical performance is degraded. When the value falls below a lower limit of the conditional inequality of Equation (3), the thickness at the outer peripheral part of the intermediate layer 103 is reduced, and the optical performance is degraded.

When a thickness of the sticky layer 104 is denoted by t₄ [mm], the optical system 100 according to each of the examples preferably satisfies the following conditional inequality of Equation (4),

$$0.005 \leq {t}_{4} \leq 0.15 . \qquad ( 4 )$$

The conditional inequality of Equation (4) relates to the thickness of the sticky layer 104. When the conditional inequality of Equation (4) is satisfied, the first lens 101 and the intermediate layer 103 can be appropriately cemented. When the thickness exceeds an upper limit of the conditional inequality of Equation (4), birefringence caused by extension in cementing is increased, and the optical performance is degraded. When the thickness falls below a lower limit of the conditional inequality of Equation (4), an air layer is generated on the surface of the first lens 101 to scatter incident light, and resolution unevenness occurs to degrade the optical performance.

When a refractive index of the sticky layer 104 is denoted by N₄, a refractive index of the first lens 101 is denoted by N₁, and a refractive index of the intermediate layer 103 on a side cemented to the first lens 101 is denoted by N₃a, the optical system 100 according to each of the examples preferably satisfies the following conditional inequality of Equation (5),

$$0.95 \leq ( {N}_{1} + {N}_{3} a ) / ( 2 \times {N}_{4} ) \leq 1 \text{.10} . \qquad ( 5 )$$

The conditional inequality of Equation (5) relates to the refractive indices of the sticky layer 104 and the first lens 101. When the conditional inequality of Equation (5) is satisfied, light reflection at an interface between the sticky layer 104 and the first lens 101 can be suppressed, and ghost light is reduced. When the value exceeds an upper limit of the conditional inequality of Equation (5) or falls below a lower limit of the conditional inequality of Equation (5), light reflection at the interface between the sticky layer 104 and the first lens 101 is increased, ghost light is accordingly generated, and the optical performance is degraded.

When a thickness of the adhesive layer 105 is denoted by t₅ [mm], the optical system 100 according to each of the examples preferably satisfies the following conditional inequality of Equation (6),

$$0.005 \leq {t}_{5} \leq 0.15 . \qquad ( 6 )$$

The conditional inequality of Equation (6) relates to the thickness of the adhesive layer 105. When the conditional inequality of Equation (6) is satisfied, the second lens 102 and the intermediate layer 103 can be appropriately cemented. When the thickness exceeds an upper limit of the conditional inequality of Equation (6), birefringence is caused by illuminance unevenness in curing, contraction of the adhesive in curing is increased to cause distortion of an adhesive surface, and the optical performance is degraded. When the thickness falls below a lower limit of the conditional inequality of Equation (6), an air layer is generated on the surface of the second lens 102 to scatter incident light, and resolution unevenness occurs to degrade the optical performance.

When a refractive index of the adhesive layer 105 is denoted by N₅, a refractive index of the second lens 102 is denoted by N₂, and a refractive index of the intermediate layer 103 on a side cemented to the second lens 102 is denoted by N₃b, the optical system 100 according to each of the examples preferably satisfies the following conditional inequality of Equation (7),

$$0.95 \leq ( {N}_{2} + {N}_{3} b ) / ( 2 \times {N}_{5} ) \leq 1 \text{.10} . \qquad ( 7 )$$

The conditional inequality of Equation (7) relates to the refractive indices of the adhesive layer 105 and the second lens 102. When the conditional inequality of Equation (7) is satisfied, light reflection at an interface between the adhesive layer 105 and the second lens 102 can be suppressed, and ghost light is reduced. When the value exceeds an upper limit of the conditional inequality of Equation (7) or falls below a lower limit of the conditional inequality of Equation (7), light reflection at the interface between the adhesive layer 105 and the second lens 102 is increased, ghost light is accordingly generated, and the optical performance is degraded.

### (Image Display Apparatus and Imaging Apparatus)

Specific application examples of the above-described optical system 100 are described. As the specific application examples, the optical system 100 can be applied as an optical system that guides light from a display side to an observation side in an ocular optical system for an image display apparatus such as a head-mounted display. In an optical system for an imaging apparatus including an imaging element, such as a camera and a video camera, the optical system 100 can be applied as an optical system that guides light from an object side to an image side. The optical system 100 includes a plurality of optical elements, and at least one of the plurality of optical elements can be used as the optical system 100 according to the exemplary embodiment.

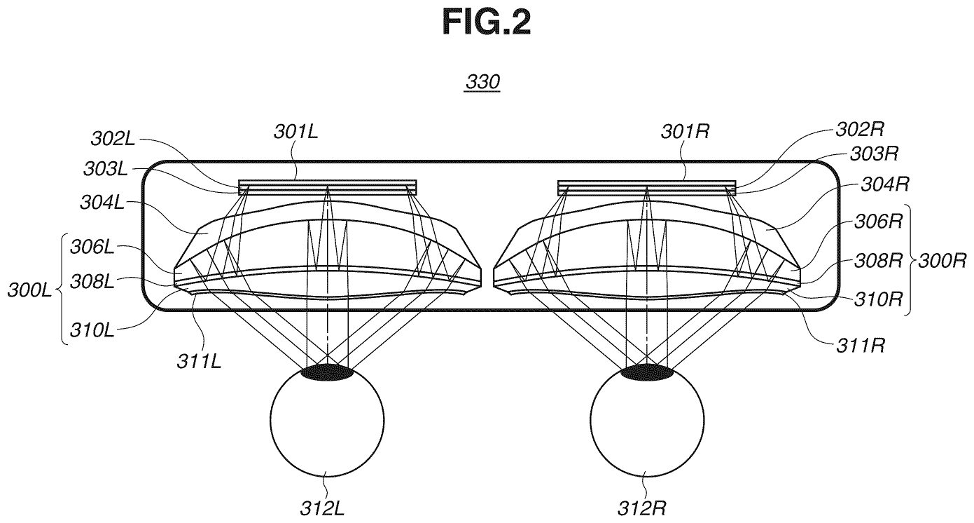

FIG. 2 illustrates a configuration of a head-mounted display 330 (hereinafter, HMD 330) that is an example of a preferred exemplary embodiment of the image display apparatus using the optical system 100 according to the exemplary embodiment. In FIG. 2, a right eye of an observer is denoted by 312R, and a left eye of the observer is denoted by 312L.

The HMD 330 includes a right-eye ocular optical system including optical elements 304R to 311R, and a left-eye ocular optical system including optical elements 304L to 311L. A right-eye image display element 301R and a left-eye image display element 301L each correspond to, for example, an organic electroluminescence (EL) display. Polarizers 302R and 302L and phase plates 303R and 303L are disposed between the image display elements 301R and 301L and the optical elements 304R and 304L, respectively, and convert non-polarized light emitted from the image display elements 301R and 301L into circularly-polarized light.

The right-eye ocular optical system enlarges and projects an original image displayed on the right-eye image display element 301R as a virtual image, and guides the image to the right eye 312R of the observer. The left-eye ocular optical system enlarges and projects an original image displayed on the left-eye image display element 301L as a virtual image, and guides the image to the left eye 312L of the observer.

The ocular optical systems are optical systems in which an optical path is folded by using polarization, and a half mirror (semi-transmissive reflective surface) is deposited on a second surface of each of the optical elements 304R and 304L. The ocular optical systems are cemented to the optical elements 306R and 306L with the half mirrors formed on the optical elements 304R and 304L in between through the adhesive layers, thereby functioning as optical elements including the semi-transmissive reflective surfaces.

Further, the optical systems 100 according to the exemplary embodiment are disposed on surfaces of the optical elements 306R and 306L on a side closer to the eye such that the sticky layers, the phase plates, the intermediate layers 308R and 308L on which the polarization separation elements are stacked, the adhesive layers, and the optical elements 310R and 310L are arranged in order from the display side.

The phase plates and the polarization separation elements may be bonded to the optical elements 306R and 306L after being stacked in a planar shape, or the phase plates and the polarization separation elements may be bonded to the optical elements 306R and 306L in order. The phase plates are wavelength plates each having a phase difference of λ/4.

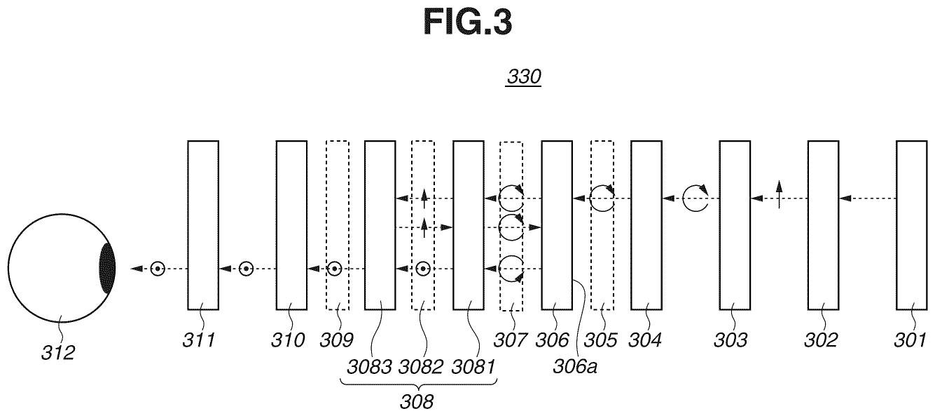

FIG. 3 is an enlarged view of the above-described right-eye ocular optical system and left-eye ocular optical system. The HMD 330 includes, in order from the display side, an image display element 301, a polarizer 302, a phase plate 303, a third lens 304, an adhesive layer 305, a first lens 306, a sticky layer 307, an intermediate layer 308, a sticky layer 309, a second lens 310, and a polarizer 311. The first lens 306 includes a half mirror 306a on a surface on the display side. The intermediate layer 308 includes a ¼-wavelength plate 3081, a sticky layer 3082, and a polarization separation element 3083. The third lens 304 is a lens made of a resin material such as COC, COP, acrylic, polycarbonate, and polyester, as with the first lens and the second lens.

An optical path in a case of the above-described configuration is described with reference to FIG. 3. Light emitted from the image display element 301 passes through the polarizer 302 and turns into linearly-polarized light, and the linearly-polarized light passes through the phase plate 303 and turns into circularly-polarized light. After passing through the third lens 304, the circularly-polarized light passes through the half mirror 306a and the first lens 306, then passes through the ¼-wavelength plate 3081, and turns into linearly-polarized light. A polarization direction of the linearly-polarized light is orthogonal to a polarization direction in which light is allowed to pass through the polarization separation element 3083. For this reason, the linearly-polarized light is reflected by the polarization separation element 3083, then passes through the ¼-wavelength plate 3081, and turns into circularly-polarized light.

After passing through the first lens 306, the circularly-polarized light is reflected by the half mirror 306a and passes through the first lens 306, then passes through the ¼-wavelength plate 3081, and turns into linearly-polarized light. At this time, the polarization direction of the linearly-polarized light is coincident with the polarization direction in which light is allowed to pass through the polarization separation element 3083. For this reason, the linearly-polarized light passes through the polarization separation element 3083, passes through the second lens 310 and the polarizer 311, and is finally guided to an eye 312 of the observer. The polarizer 311 is disposed, which makes it possible to reduce ghost light of outside light and to enhance contrast of an observation image. An antireflective film is formed or an antireflective film is bonded on an interface of each optical element with air, which makes it possible to reduce ghost light.

In the image display apparatus illustrated in FIG. 3, the sticky layer and the adhesive layer are appropriately disposed depending on the number of times incident light passes through a region. More specifically, for example, in a region through which incident light passes three times as with a region between the first lens 306 and the intermediate layer 308, the sticky layer is disposed, whereas in a region through which the incident light passes once as with a region between the second lens 310 and the intermediate layer 308, the adhesive layer is disposed. With such a configuration, it is possible to suppress reduction in image quality in a region through which the incident light passes three times or more, the region requiring management of the polarization state, and to enhance the optical performance.

### (Manufacturing Method)

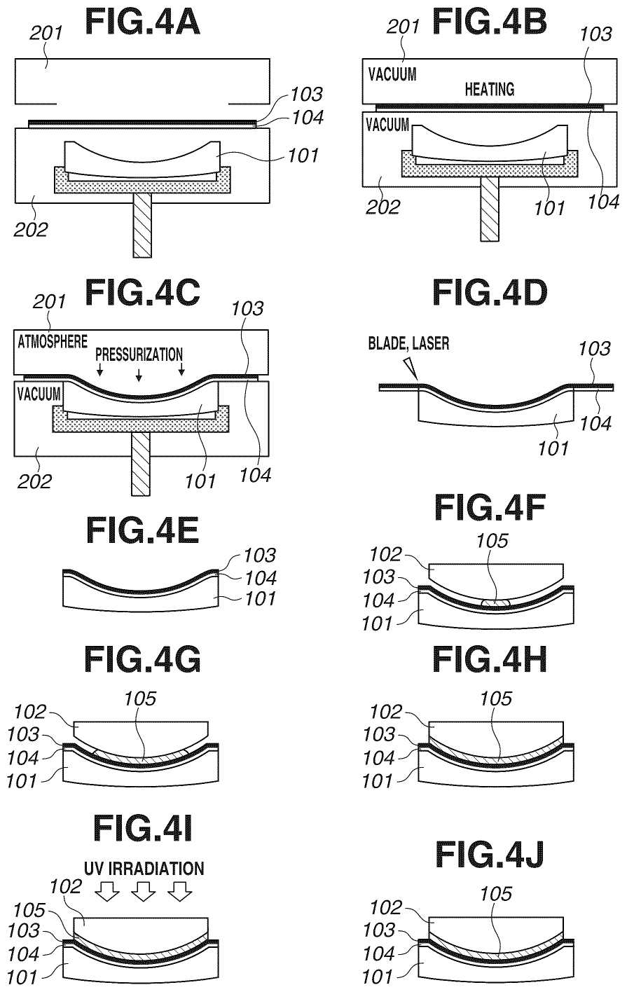

A method of manufacturing the optical system 100 according to the exemplary embodiment is described with reference to FIGS. 4A to 4J.

The first lens 101 is disposed in a second chamber 202, and the intermediate layer 103 is disposed between the second chamber 202 and a first chamber 201. At this time, the intermediate layer 103 is disposed to face the first lens 101, and the uniform sticky layer 104 is provided on a surface of the intermediate layer 103 closer to the first lens 101.

As illustrated in FIG. 4B, insides of the first chamber 201 and the second chamber 202 are evacuated, and the intermediate layer 103 disposed inside the second chamber 202 is heated. As illustrated in FIG. 4C, after the intermediate layer 103 is heated to a desired temperature, the first lens 101 and the intermediate layer 103 are brought into contact with each other. Only the inside of the first chamber 201 is exposed to atmosphere, to increase pressure. Further, high-pressure gas is introduced into the first chamber 201 to pressurize and press the intermediate layer 103 against the first lens 101.

As illustrated in FIG. 4D, heating and pressurization of the intermediate layer 103 are stopped, and the inside of the first chamber 201 is returned to atmospheric pressure. The inside of the second chamber 202 is also exposed to atmosphere, and the intermediate layer 103 and the first lens 101 are taken out from the second chamber 202. Thereafter, as illustrated in FIG. 4E, an unnecessary portion of the intermediate layer 103 is cut away such that the intermediate layer 103 remains only on the first lens 101. As a cutting-away method, the unnecessary portion of the intermediate layer 103 may be cut away along an outer edge of the first lens 101 by using a blade of a cutter or the like, or by applying a laser beam along the outer edge of the first lens 101. In the above-described manner, the intermediate layer 103 is cemented to the first lens 101 through the sticky layer 104.

By cementing the first lens 101 and the intermediate layer 103 with the sticky layer 104 as described above, it is possible to perform cementing irrespective of a material and a shape of the first lens 101. The adhesive layer 105 in an uncured liquid form as a precursor is applied to a surface of the first lens 101 cemented to the intermediate layer 103. A method of applying the adhesive layer 105 in the liquid form is not particularly limited, and for example, a dispenser can be used.

The first lens 101 and the second lens 102 are aligned using a jig (not illustrated) such that a center of the first lens 101 and a center of the second lens 102 are coincident with each other, while the first lens 101 and the second lens 102 are brought close to each other. Thereafter, as illustrated in FIGS. 4G and 4H, the second lens 102 is brought close to the first lens 101 to fill a space between the second lens 102 and the first lens 101 with the adhesive layer 105 in the liquid form in a radial direction. The second lens 102 is brought close to the first lens 101 until a thickness of the adhesive layer 105 becomes a desired thickness.

As illustrated in FIG. 4I, the adhesive layer 105 is irradiated with light having a wavelength of 360 nm or more from a light source through the second lens 102. This starts curing reaction of the adhesive layer 105 in the liquid form. If irradiation is performed from the first lens 101, the adhesive layer 105 in the liquid form is irradiated with the light through the intermediate layer 103. Accordingly, it takes a time to cure the adhesive layer 105. The second lens 102 is preferably made of a material with a thickness having the maximum transmittance of 50% or more for light having a wavelength of 360 nm or more and 400 nm or less.

After the adhesive layer 105 is irradiated with the light having the wavelength of 360 nm or more for a certain time, the optical system 100 illustrated in FIG. 4J is obtained.

In the above description, the adhesive layer 105 is applied to the first lens 101, but may be applied to the second lens 102. The adhesive layer 105 may be applied to both the first lens 101 and the second lens 102.

When the first lens 101 and the second lens 102 are cemented with the sticky agent, the relative positions of the first lens 101 and the second lens 102 cannot be adjusted. According to the manufacturing method, the first lens 101 and the second lens 102 can be cemented while the relative positions of the first lens 101 and the second lens 102 are adjusted, irrespective of the materials and the shapes of the first lens 101 and the second lens 102. This makes it possible to obtain high optical performance.

Specific configurations of the optical system 100 according to the present exemplary embodiment are described in detail.

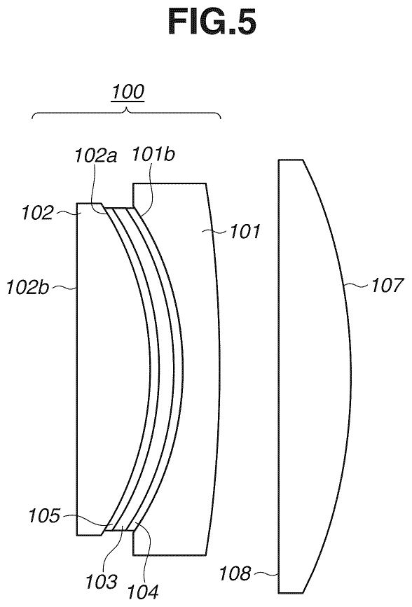

A first example is described. The optical system 100 having a configuration illustrated in FIG. 5 was fabricated by the manufacturing method illustrated in FIGS. 4A to 4J.

The first lens 101 was a lens including a concave surface that had the refractive index N₁ of 1.54, and the maximum half aperture angle θ of the concave surface was 30 degrees.

The second lens 102 was a lens including a convex surface that had the transmittance of 85% and the refractive index N₂ of 1.54, and the maximum half aperture angle θ of the convex surface was 30 degrees. The second lens 102 had a convex surface shape identical to the concave surface of the first lens 101.

The intermediate layer 103 included a polarization separation element, and the thickness t₃ was 0.075 mm. The refractive index N₃a of the intermediate layer 103 on the side cemented to the first lens 101 was 1.56, and the refractive index N₃b of the intermediate layer 103 on the side cemented to the second lens 102 was 1.56. The variation t₂/t₁ of the thickness t₁ of the intermediate layer 103 in the surface normal direction on the optical axis when the intermediate layer 103 was cemented to the first lens 101 and the thickness t₂ of the intermediate layer 103 in the surface normal direction at an optional position was 1.05.

The sticky layer 104 was provided on the side cemented to the first lens 101, of the intermediate layer 103. The thickness t₄ of the sticky layer 104 was 0.020 mm, and the refractive index N₄ was 1.48.

The adhesive layer 105 was made of a photocurable adhesive in a liquid form, and provided on the side cemented to the second lens 102, of the intermediate layer 103. The thickness t₅ of the adhesive layer 105 was 0.050 mm, and the refractive index N₅ after curing was 1.50.

Table 1 illustrates various characteristics of the first lens 101, the second lens 102, the intermediate layer 103, the sticky layer 104, and the adhesive layer 105.

TABLE 1

| Item | | | First Example |
|---|---|---|---|
| First Lens 101 | Surface Shape | | Concave: Spherical |
| | | | Surface |
| | Half Aperture | Θ₁(degree) | 30 |
| | Angle | | |
| | Refractive Index | N₁ | 1.54 |
| Second Lens 102 | Surface Shape | | Convex: Spherical |
| | | | Surface |
| | Half Aperture | Θ₂(degree) | 30 |
| | Angle | | |
| | Refractive Index | N₂ | 1.54 |
| | Transmittance | T(%) | 85 |
| Intermediate | Thickness | t₃(mm) | 0.075 |
| Layer 103 | Thickness | t₂/t₁ | 1.05 |
| | Variation | | |
| | Refractive Index | N₃a | 1.56 |
| | | N₃b | 1.56 |
| Sticky Layer 104 | Thickness | t₄(mm) | 0.020 |
| | Refractive Index | N₄ | 1.48 |
| | (N₁ + N₃a)/(2 × N₄) | | 1.05 |
| Adhesive | Thickness | t₅(mm) | 0.050 |
| Layer 105 | Refractive Index | N₅ | 1.50 |

| | |
|---|---|
| (N₂ + N₃b)/(2 × N₅) | 1.03 |

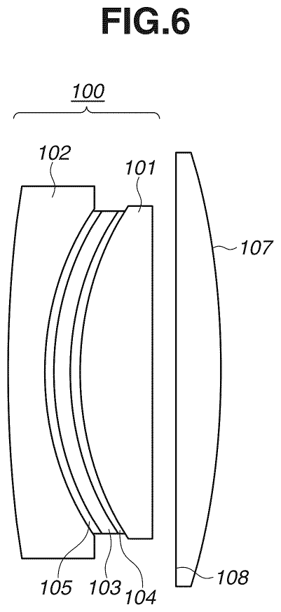

A second example is described. The optical system 100 having a configuration illustrated in FIG. 6 was manufactured by a procedure that is the same as the procedure in the first example.

The first lens 101 was a lens including a convex surface that had the refractive index N₁ of 1.50, and the maximum half aperture angle θ was 30 degrees.

The second lens 102 was a lens including a concave surface that had the transmittance of 85% and the refractive index N₂ of 1.54, and the maximum half aperture angle θ was 30 degrees. The second lens 102 had a concave surface shape identical to the convex surface of the first lens 101.

The intermediate layer 103 included a polarization separation element, and the thickness t₃ was 0.075 mm. The refractive index N₃a of the intermediate layer 103 on the side cemented to the first lens 101 was 1.56, and the refractive index N₃b of the intermediate layer 103 on the side cemented to the second lens 102 was 1.56. The variation t₂/t₁ of the thickness t₁ of the intermediate layer 103 in the surface normal direction on the optical axis when the intermediate layer 103 was cemented to the first lens 101 and the thickness t₂ of the intermediate layer 103 in the surface normal direction at an optional position was 0.95.

The sticky layer 104 was provided on the side cemented to the first lens 101, of the intermediate layer 103. The thickness t₄ of the sticky layer 104 was 0.020 mm, and the refractive index N₄ was 1.48.

The adhesive layer 105 was made of a photocurable adhesive in a liquid form, and provided on the side cemented to the second lens 102, of the intermediate layer 103. The thickness t₅ of the adhesive layer 105 was 0.050 mm, and the refractive index N₅ after curing was 1.50.

Table 2 illustrates various characteristics of the first lens 101, the second lens 102, the intermediate layer 103, the sticky layer 104, and the adhesive layer 105.

TABLE 2

| Item | | | Second Example |
|---|---|---|---|
| First Lens 101 | Surface Shape | | Convex: Spherical |
| | | | Surface |
| | Half Aperture | Θ₁(degree) | 30 |
| | Angle | | |
| | Refractive Index | N₁ | 1.50 |
| Second Lens 102 | Surface Shape | | Concave: Spherical |
| | | | Surface |
| | Half Aperture | Θ₂(degree) | 30 |
| | Angle | | |
| | Refractive Index | N₂ | 1.54 |
| | Transmittance | T(%) | 85 |
| Intermediate | Thickness | t₃(mm) | 0.075 |
| Layer 103 | Thickness | t₂/t₁ | 0.95 |
| | Variation | | |
| | Refractive Index | N₃a | 1.56 |
| | | N₃b | 1.56 |
| Sticky Layer 104 | Thickness | t₄(mm) | 0.020 |
| | Refractive Index | N₄ | 1.48 |
| | (N₁ + N₃a)/(2 × N₄) | | 1.03 |
| Adhesive | Thickness | t₅(mm) | 0.050 |
| Layer 105 | Refractive Index | N₅ | 1.50 |

| | |
|---|---|
| (N₂ + N₃b)/(2 × N₅) | 1.03 |

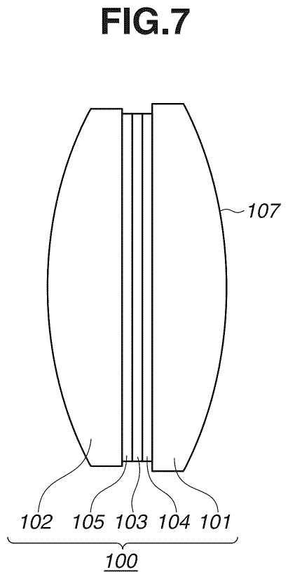

A third example is described. The optical system 100 having a configuration illustrated in FIG. 7 was manufactured by a procedure that is the same as the procedure in the first example.

The first lens 101 was a plane lens having the refractive index N₁ of 1.64, and the maximum half aperture angle θ was 0 degrees.

The second lens 102 was a plane lens having the transmittance of 85% and the refractive index N₂ of 1.54, and the maximum half aperture angle θ was 0 degrees.

The intermediate layer 103 included a polarization separation element, and the thickness t₃ was 0.400 mm. The refractive index N₃a of the intermediate layer 103 on the side cemented to the first lens 101 was 1.54, and the refractive index Nab of the intermediate layer 103 on the side cemented to the second lens 102 was 1.56. The variation t₂/t₁ of the thickness t₁ of the intermediate layer 103 in the surface normal direction on the optical axis when the intermediate layer 103 was cemented to the first lens 101 and the thickness t₂ of the intermediate layer 103 in the surface normal direction at an optional position was 1.00.

The sticky layer 104 was provided on the side cemented to the first lens 101, of the intermediate layer 103. The thickness t₄ of the sticky layer 104 was 0.020 mm, and the refractive index N₄ was 1.48.

The adhesive layer 105 was made of a photocurable adhesive in a liquid form, and provided on the side cemented to the second lens 102, of the intermediate layer 103. The thickness t₅ of the adhesive layer 105 was 0.005 mm, and the refractive index N₅ after curing was 1.50.

Table 3 illustrates various characteristics of the first lens 101, the second lens 102, the intermediate layer 103, the sticky layer 104, and the adhesive layer 105.

TABLE 3

| Item | | | Third Example |
|---|---|---|---|
| First Lens 101 | Surface Shape | | Plane |
| | Half Aperture | Θ₁(degree) | 0 |
| | Angle | | |
| | Refractive Index | N₁ | 1.64 |
| Second Lens 102 | Surface Shape | | Plane |
| | Half Aperture | Θ₂(degree) | 0 |
| | Angle | | |
| | Refractive Index | N₂ | 1.54 |
| | Transmittance | T(%) | 85 |
| Intermediate | Thickness | t₃(mm) | 0.4 |
| Layer 103 | Thickness | t₂/t₁ | 1 |
| | Variation | | |
| | Refractive Index | N₃a | 1.54 |
| | | N₃b | 1.56 |
| Sticky Layer 104 | Thickness | t₄(mm) | 0.020 |
| | Refractive Index | N₄ | 1.48 |
| | (N₁ + N₃a)/(2 × N₄) | | 1.07 |
| Adhesive | Thickness | t₅(mm) | 0.005 |
| Layer 105 | Refractive Index | N₅ | 1.50 |

| | |
|---|---|
| (N₂ + N₃b)/(2 × N₅) | 1.03 |

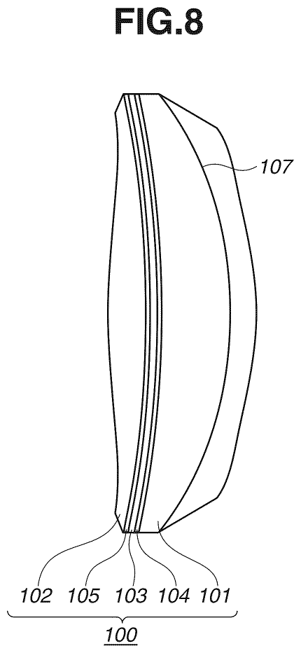

A fourth example is described. The optical system 100 having a configuration illustrated in FIG. 8 was manufactured by a procedure that is the same as the procedure in the first example.

The first lens 101 was an aspherical lens including a concave surface that had the refractive index N₁ of 1.50, and the maximum half aperture angle θ was 30 degrees.

The second lens 102 was an aspherical lens including a convex surface that had the transmittance of 85% and the refractive index N₂ of 1.54, and the maximum half aperture angle θ was 30 degrees. The second lens 102 had a convex surface shape identical to the concave surface of the first lens 101.

The intermediate layer 103 included a polarization separation element, and the thickness t₃ was 0.400 mm. The refractive index N₃a of the intermediate layer 103 on the side cemented to the first lens 101 was 1.54, and the refractive index N₃b of the intermediate layer 103 on the side cemented to the second lens 102 was 1.56. The variation t₂/t₁ of the thickness t₁ of the intermediate layer 103 in the surface normal direction on the optical axis when the intermediate layer 103 was cemented to the first lens 101 and the thickness t₂ of the intermediate layer 103 in the surface normal direction at an optional position was 0.98.

The sticky layer 104 was provided on the side cemented to the first lens 101, of the intermediate layer 103. The thickness t₄ of the sticky layer 104 was 0.020 mm, and the refractive index N₄ was 1.48.

The adhesive layer 105 was made of a photocurable adhesive in a liquid form, and provided on the side cemented to the second lens 102, of the intermediate layer 103. The thickness t₅ of the adhesive layer 105 was 0.050 mm, and the refractive index N₅ after curing was 1.50.

Table 4 illustrates various characteristics of the first lens 101, the second lens 102, the intermediate layer 103, the sticky layer 104, and the adhesive layer 105.

TABLE 4

| Item | | | Fourth Example |
|---|---|---|---|
| First Lens 101 | Surface Shape | | Concave: Aspherical |
| | | | Surface |
| | Half Aperture | Θ₁(degree) | 30 |
| | Angle | | |
| | Refractive Index | N₁ | 1.50 |
| Second Lens 102 | Surface Shape | | Convex: Aspherical |
| | | | Surface |
| | Half Aperture | Θ₂(degree) | 30 |
| | Angle | | |
| | Refractive Index | N₂ | 1.54 |
| | Transmittance | T(%) | 85 |
| Intermediate | Thickness | t₃(mm) | 0.400 |
| Layer 103 | Thickness | t₂/t₁ | 0.98 |
| | Variation | | |
| | Refractive Index | N₃a | 1.54 |
| | | N₃b | 1.56 |
| Sticky Layer 104 | Thickness | t₄(mm) | 0.020 |
| | Refractive Index | N₄ | 1.48 |
| | (N₁ + N₃a)/(2 × N₄) | | 1.03 |
| Adhesive | Thickness | t₅(mm) | 0.050 |
| Layer 105 | Refractive Index | N₅ | 1.50 |

| | |
|---|---|
| (N₂ + N₃b)/(2 × N₅) | 1.03 |

Although the preferred exemplary embodiment and the examples according to the disclosure of the present specification are described, the disclosure of the present specification is not limited to the exemplary embodiment and the examples, and various combinations, modifications, and changes can be made within the scope of the spirit.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-092831, filed Jun. 7, 2024, the entirety of which is incorporated herein by reference.

What is claimed is:

1. An optical system for guiding light from a display side to an observation side, the optical system comprising:
an intermediate layer including a polarization separation element;
a first lens; and
a second lens,
wherein the first lens and the intermediate layer are cemented to each other through a sticky layer,
wherein the second lens and the intermediate layer are cemented to each other through an adhesive layer, and
wherein a number of times the light passes through the sticky layer is greater than a number of times the light passes through the adhesive layer.

2. The optical system according to claim 1,
wherein the first lens is disposed closer to the display side than the second lens, and
wherein the light passes through the sticky layer three or more times.

3. The optical system according to claim 1, wherein the intermediate layer includes, in order from the display side, the polarization separation element, and a semi-transmissive reflective surface.

4. The optical system according to claim 1,
wherein the sticky layer is made of a resin material configured to exhibit adhesiveness in response to receiving pressure, and
wherein the adhesive layer is made of a photocurable resin or a thermosetting resin.

5. The optical system according to claim 1, wherein the second lens has a maximum transmittance of 50% or more for incident light having a wavelength of 360 nm to 400 nm.

6. The optical system according to claim 1, wherein: 0.95≤t₂/t₁≤1.05, where t₁ is a thickness of the intermediate layer in a surface normal direction on an optical axis, and t₂ is a thickness of the intermediate layer in the surface normal direction at an optional position.

7. The optical system according to claim 6,
wherein the first lens includes a first surface cemented to the intermediate layer, and
wherein:
$$0 \leq θ \leq 30 ,$$
where θ is a maximum half aperture angle of the first surface.

8. The optical system according to claim 1, wherein: 0.005≤t₄≤0.150, and
$$0.95 \leq ( {N}_{1} + {N}_{3} a ) / ( 2 \times {N}_{4} ) \leq 1.1 ,$$
where t₄ is a thickness of the sticky layer, N₄ is a refractive index of a material of the sticky layer, N₁ is a refractive index of a material of the first lens, and N₃a is a refractive index of the intermediate layer on a side cemented to the first lens.

9. The optical system according to claim 1, wherein:
$$0.005 \leq {t}_{5} \leq 0.15 , and 0.95 \leq ( {N}_{2} + {N}_{3} b ) / ( 2 {\times }_{5} ) \leq 1.1 ,$$
where t₅ is a thickness of the adhesive layer, N₅ is a refractive index of a material of the adhesive layer, N₂ is a refractive index of a material of the second lens, and N₃b is a refractive index of the intermediate layer on a side cemented to the second lens.

10. The optical system according to claim 1,
wherein the first lens includes a first surface cemented to the intermediate layer, and
wherein the first surface has an aspherical surface shape.

11. The optical system according to claim 1,
wherein the first lens includes a first surface cemented to the intermediate layer,
wherein the second lens includes a second surface cemented to the intermediate layer, and
wherein the first surface and the second surface are different in shape.

12. An image display apparatus comprising:
an optical system; and
an image display element,
wherein the optical system guides light from a display side to an observation side,
wherein the optical system includes an intermediate layer including a polarization separation element, a first lens, and a second lens,
wherein the first lens and the intermediate layer are cemented to each other through a sticky layer,
wherein the second lens and the intermediate layer are cemented to each other through an adhesive layer, and
wherein a number of times the light passes through the sticky layer is greater than a number of times the light passes through the adhesive layer.

13. An optical system for guiding light from a display side to an observation side, the optical system comprising, in order from the display side:
a first lens;
a semi-transmissive reflective surface;
a second lens;
a ¼-wavelength plate;
a polarization separation element; and
a third lens,
wherein an element including the semi-transmissive reflective surface and the first lens are cemented to each other through a sticky layer, and the second lens and the ¼-wavelength plate are cemented to each other through an other sticky layer,
wherein the polarization separation element and the third lens are cemented to each other through an adhesive layer,
wherein incident light from the display side is reflected by the polarization separation element, is then reflected by the element including the semi-transmissive reflective surface, and is guided to the observation side, and
wherein a number of times the light passes through the sticky layer is greater than a number of times the light passes through the adhesive layer.
